(19) United States
(12) Patent Application Publication
(10) Pub. No.: US 2026/0267023 A1
(43) Pub. Date: Sep. 10, 2026

(54) Methods and Systems of Sparse Angle Gather Generation in Wave-Equation Migration

(71) Applicant: BP Corporation North America Inc., Houston, TX (US)

(72) Inventors: Hu JIN, Houston, TX (US); Phuong VU, Houston, TX (US); Qingqing LIAO, Medina, MN (US); Zhou YU, Katy, TX (US); Chunlei CHU, Katy, TX (US)

(73) Assignee: BP Corporation North America Inc., Houston, TX (US)

(21) Appl. No.: 19/557,892

(22) Filed: Mar. 5, 2026

Related U.S. Application Data
(60) Provisional application No. 63/767,253, filed on Mar. 5, 2025.

(51) Int. Cl. G01V 1/32; G01V 1/34; G01V 1/38

(52) U.S. Cl. CPC G01V 1/32; G01V 1/34; G01V 1/3808

(57) ABSTRACT

A method includes obtaining source wavefields and receiver wavefields; transforming, using an integral transform, the source wavefields and the receiver wavefields into a wavenumber domain to respectively obtain source wavenumbers and receiver wavenumbers; separating, based on pre-defined propagation directions in the wavenumber domain, the source wavenumbers and the receiver wavenumbers into sectors; discarding one or more sectors from the sectors; applying, to the sectors after discarding the one or more sectors, a reconstruction transform to transform the sectors into angle-dependent source wavefields and angle-dependent receiver wavefields of corresponding propagation directions in the space-time domain; and convolving the angle-dependent source wavefields and the angle-dependent receiver wavefields to calculate angle gathers.

### CROSS-REFERENCE TO RELATED APPLICATIONS

The present application claims priority to U.S. Provisional Application No. 63/767,253 filed on Mar. 5, 2025 and entitled, “METHODS AND SYSTEMS OF SPARSE ANGLE GATHER GENERATION IN WAVE-EQUATION MIGRATION,” which is incorporated herein by reference in its entirety.

### BACKGROUND

Seismic surveying is a geophysical technique used to investigate the subsurface structure of the Earth by sending shock waves or vibrations into the ground and analyzing the reflected waves. Seismic waves are reflected when they encounter boundaries between different layers of subsurface materials, such as rock, sediment, or fluid. These layers have different densities, which cause the seismic waves to change speed and direction upon encountering the boundary. When a seismic wave propagates through the Earth and strikes a boundary between materials of different densities, a part of the seismic wave energy is transmitted into the new layer and the remainder is reflected back toward the surface. The reflected seismic wave energy is observed at the surface as seismic data and may be studied to ascertain information about the subsurface region. For example, the observed seismic data may be used to construct a velocity model of the subsurface region which models the velocity of the seismic waves passing through the subsurface region so as to translate subsurface reflection points of the seismic waves to their true depth within the formation. Furthermore, the seismic data observed by the receivers may also be used to create an image or profile of the corresponding subsurface region. Interpretation of these seismic images may provide a description of composition, density, and depth of subsurface materials and aids in resource extraction, hazard assessment, and environmental impact studies of the subsurface.

### SUMMARY

In an embodiment, a method comprises obtaining source wavefields and receiver wavefields, wherein the source wavefields and the receiver wavefields are in a space-time domain; transforming, using an integral transform, the source wavefields and the receiver wavefields into a wavenumber domain to respectively obtain source wavenumbers and receiver wavenumbers; separating, based on pre-defined propagation directions in the wavenumber domain, the source wavenumbers and the receiver wavenumbers into sectors; discarding one or more sectors from the sectors; applying, to the sectors after discarding the one or more sectors, a reconstruction transform to transform the sectors into angle-dependent source wavefields and angle-dependent receiver wavefields of corresponding propagation directions in the space-time domain; and convolving the angle-dependent source wavefields and the angle-dependent receiver wavefields to calculate angle gathers. In some embodiments, the integral transform comprises a three-dimensional (3D) Fourier transform, a complex wavelet transform (CWT), a slant stack transform, a radon transform, or a Curvelet transform. In some other embodiments, the reconstruction transform comprises an inverse Fourier transform, an inverse CWT, an inverse slant stack transform, an inverse radon transform, or an inverse Curvelet transform. In certain other embodiments, after obtaining the source wavefields and the receiver wavefields, the method further comprises performing, using a Hilbert transform, up/down separation on the source wavefields to obtain up-going source wavefields and down-going source wavefields; performing, using the Hilbert transform, the up/down separation on the receiver wavefields to obtain up-going receiver wavefields and down-going receiver wavefields; and transforming, using the integral transform, the down-going source wavefields and the up-going receiver wavefields into the time-wavenumber domain to respectively obtain the source wavenumbers and the receiver wavenumbers. In other embodiments, after obtaining the source wavefields and the first receiver wavefields, the method further comprises performing one-dimensional (1D) Fourier transform on the source wavefields and the receiver wavefields to transform the source wavefields and the receiver wavefields into a space-frequency domain; and transforming, using the integral transform, the source wavefields and the receiver wavefields that is in the space-frequency domain into wavenumber-frequency domain. In some embodiments, the pre-defined propagation directions each comprise equal angle ranges. In some other embodiments, the pre-defined propagation directions each comprise random angle ranges. In some embodiments, discarding the one or more sectors from the sectors further comprises discarding an initial sector of the sectors and a last sector of the sectors. In certain embodiments, before separating the source wavenumbers and the receiver wavenumbers into the sectors, the method further comprises obtaining, using a user interface and from a user, the pre-defined propagation directions. In some embodiments, before separating the source wavenumbers and the receiver wavenumbers into the sectors, the method further comprises obtaining, using a feature selection algorithm and a machine learning model, the pre-defined propagation directions. In an embodiment, a computing system comprises a memory configured to store instructions; and one or more processors coupled to the memory and configured to execute the instructions to cause the computing system to obtain source wavefields and receiver wavefields, wherein the source wavefields and the receiver wavefields are in a space-time domain; transform, using an integral transform, the source wavefields and the receiver wavefields into a wavenumber domain to respectively obtain source wavenumbers and receiver wavenumbers; separate, based on pre-defined propagation directions in the wavenumber domain, the source wavenumbers and the receiver wavenumbers into sectors; discard one or more sectors from the sectors; apply, to the sectors after discarding the one or more sectors, a reconstruction transform to transform the sectors into angle-dependent source wavefields and angle-dependent receiver wavefields of corresponding propagation directions in the space-time domain; and convolve the angle-dependent source wavefields and the angle-dependent receiver wavefields to calculate angle gathers. In some embodiments, the integral transform comprises a 3D Fourier transform, a CWT, a slant stack transform, a radon transform, or a Curvelet transform. In some embodiments, the reconstruction transform comprises an inverse Fourier transform, an inverse CWT, an inverse slant stack transform, an inverse radon transform, or an inverse Curvelet transform. In some embodiments, the one or more processors further configured to execute the instructions to cause the apparatus to perform, using a Hilbert transform, up/down separation on the source wavefields to obtain up-going source wavefields and down-going source wavefields; perform, using a Hilbert transform, the up/down separation on the first receiver wavefields to obtain up-going receiver wavefields and down-going receiver wavefields; and transform, using the integral transform, the down-going source wavefields and the up-going receiver wavefields into the wavenumber domain to respectively obtain the source wavenumbers and the receiver wavenumbers. In certain embodiments, the one or more processors further configured to execute the instructions to cause the apparatus to perform 1D Fourier transform on the source wavefields and the receiver wavefields to transform the source wavefields and the receiver wavefields into a space-frequency domain; and transform, using the integral transform, the source wavefields and the receiver wavefields that is in the space-frequency domain into wavenumber-frequency domain. In some embodiments, the pre-defined propagation directions each comprise equal angle ranges. In some other embodiments, the pre-defined propagation directions each comprise random angle ranges. In other embodiments, the one or more processors further configured to execute the instructions to cause the apparatus to discard an initial sector of the sectors and a last sector of the sectors. In an embodiment, a computer program product comprising computer-executable instructions that are stored on a non-transitory computer-readable medium and that, when executed by one or more processors, cause a computing system to obtain source wavefields and receiver wavefields, wherein the source wavefields and the receiver wavefields are in a space-time domain; transform, using an integral transform, the source wavefields and the receiver wavefields into a wavenumber domain to respectively obtain source wavenumbers and receiver wavenumbers; separate, based on pre-defined propagation directions in the wavenumber domain, the source wavenumbers and the receiver wavenumbers into sectors; discard one or more sectors from the sectors; apply, to the sectors after discarding the one or more sectors, a reconstruction transform to transform the sectors into angle-dependent source wavefields and angle-dependent receiver wavefields of corresponding propagation directions in the space-time domain; and convolve the angle-dependent source wavefields and the angle-dependent receiver wavefields to calculate angle gathers. In some embodiments, the integral transform comprises a 3D Fourier transform, a CWT, a slant stack transform, a radon transform, or a Curvelet transform, and wherein the reconstruction transform comprises an inverse Fourier transform, an inverse CWT, an inverse slant stack transform, an inverse radon transform, or an inverse Curvelet transform.

### BRIEF DESCRIPTION OF THE DRAWINGS

For a detailed description of various exemplary embodiments, reference will now be made to the accompanying drawings in which:

FIG. 1 is a flow chart of various processes that may be performed based on analysis of seismic data acquired via a seismic survey system according to various embodiments disclosed herein;

FIG. 2 is a schematic diagram of an embodiment of a system for performing a marine seismic survey according to various embodiments disclosed herein;

FIG. 3 is a schematic diagram of an embodiment of a system for performing a land-based seismic survey according to various embodiments disclosed herein;

FIG. 4 is a block diagram of an embodiment of a computer system that may perform operations described herein based on data acquired via the marine survey system of FIG. 2 and/or the land survey systems of FIG. 3 according to various embodiments described herein;

FIG. 5 is a flowchart of an embodiment of a method for generation of sparse angle gathers in wave-equation migration according to various embodiments described herein;

FIG. 6A illustrates a synthetic two-dimensional (2D) model of subsurface regions according to various embodiments described herein;

FIG. 6B depicts a source wavefield in a wavenumber domain for a single source according to various embodiments described herein;

FIG. 6C depicts separated source wavefields according to various embodiments described herein;

FIG. 6D depicts images of six reflection angles according to various embodiments described herein;

FIG. 7 is a flowchart of an embodiment of a method for generating sparse angle gathers in wave-equation migration according to various embodiments described herein;

FIG. 8 is a user interface for inputting parameters for generation of sparse angle gathers in wave-equation migration according to various embodiments described herein; and

FIG. 9 is a block diagram of an embodiment of a computer system configured to generate sparse angle gathers in wave-equation migration according to various embodiments described herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in the interest of clarity and conciseness.

In the following discussion and in the claims, the terms “including” and “comprising” are used in an open-ended fashion, and thus should be interpreted to mean “including, but not limited to...” Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a particular axis (e.g., central axis of a body or a port), while the terms “radial” and “radially” generally mean perpendicular to a particular axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees.

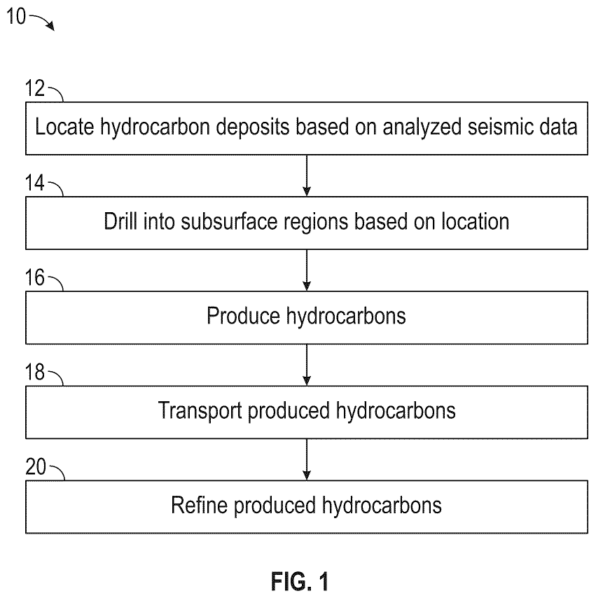

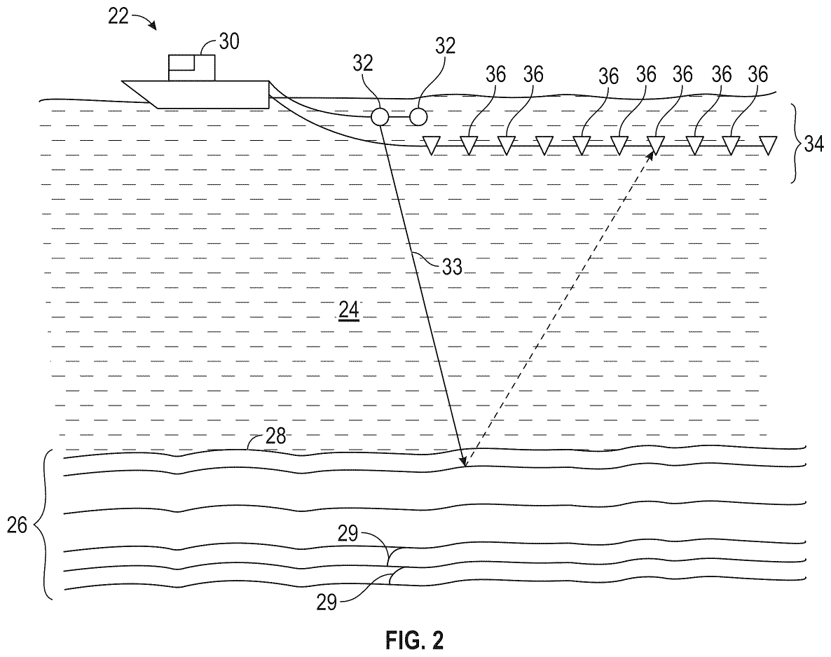

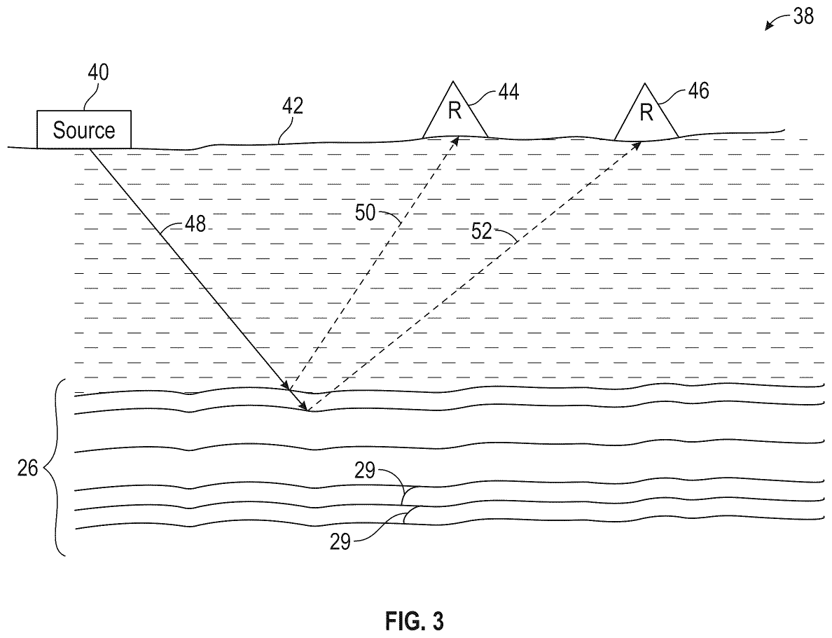

By way of introduction, seismic data may be acquired using a variety of seismic survey systems and techniques, two of which are discussed with respect to FIG. 2 and FIG. 3. Regardless of the seismic data gathering technique utilized, after the seismic data is acquired, a computing system may analyze the acquired seismic data and may use the results of the seismic data analysis (e.g., seismogram, map of geological formations, etc.) to perform various operations within the hydrocarbon exploration and production industries. For instance, FIG. 1 illustrates a flow chart of a method 10 that details various processes that may be undertaken based on the analysis of the acquired seismic data. Although the method 10 is described in a particular order, it should be noted that the method 10 may be performed in any suitable order.

Furthermore, source and receiver wavefields in seismic data are not inherently plane waves and exhibit spherical or more complex wave fronts, particularly near the source. However, both wavefields can be decomposed into plane waves using techniques like plane-wave decomposition, which isolates wave components traveling in specific directions and with particular velocities. This decomposition is especially useful for far-field propagation, where the wave fronts approximate plane waves, or for processing complex data in methods like migration and inversion. While near the source, the wavefields are generally spherical, decomposing them into plane waves simplifies the analysis and interpretation, particularly in cases involving multiple wave types or complex subsurface structures.

Referring now to FIG. 1, at block 12, locations and properties of hydrocarbon deposits within a subsurface region of the Earth associated with the respective seismic survey may be determined based on the analyzed seismic data. In one embodiment, the seismic data acquired may be analyzed to generate a map or profile that illustrates various geological formations within the subsurface region. Based on the identified locations and properties of the hydrocarbon deposits, at block 14, certain positions or parts of the subsurface region may be explored. That is, hydrocarbon exploration organizations may use the locations of the hydrocarbon deposits to determine locations at the surface of the subsurface region to drill into the Earth. As such, the hydrocarbon exploration organizations may use the locations and properties of the hydrocarbon deposits and the associated overburdens to determine a path along which to drill into the Earth, how to drill into the Earth, and the like.

After exploration equipment has been placed within the subsurface region, at block 16, the hydrocarbons that are stored in the hydrocarbon deposits may be produced via natural flowing wells, artificial lift wells, and the like. At block 18, the produced hydrocarbons may be transported to refineries and the like via transport vehicles, pipelines, and the like. At block 20, the produced hydrocarbons may be processed according to various refining procedures to develop different products using the hydrocarbons.

It should be noted that the processes discussed with regard to the method 10 may include other suitable processes that may be based on the locations and properties of hydrocarbon deposits as indicated in the seismic data acquired via one or more seismic survey. As such, it should be understood that the processes described above are not intended to depict an exhaustive list of processes that may be performed after determining the locations and properties of hydrocarbon deposits within the subsurface region.

With the foregoing in mind, FIG. 2 is a schematic diagram of a marine survey system 22 (e.g., for use in conjunction with block 12 of FIG. 1) that may be employed to acquire seismic data (e.g., waveforms) regarding a subsurface region of the Earth in a marine environment. Generally, a marine seismic survey using the marine survey system 22 may be conducted in an ocean 24 or other body of water over a subsurface region 26 of the Earth that lies beneath a seafloor 28.

The marine survey system 22 may include a vessel 30, one or more seismic sources 32, a (seismic) streamer 34, one or more (seismic) receivers 36, and/or other equipment that may assist in acquiring seismic images representative of geological formations within a subsurface region 26 of the Earth. The vessel 30 may tow the seismic source(s) 32 (e.g., an air gun array) that may produce energy, such as sound waves (e.g., seismic waveforms), that is directed at a seafloor 28. The vessel 30 may also tow the streamer 34 having a receiver 36 (e.g., hydrophones) that may acquire seismic waveforms that represent the energy output by the seismic source(s) 32 subsequent to being reflected off of various geological formations (e.g., salt domes, faults, folds, etc., represented schematically in FIG. 2 as subsurface reflectors 29) within the subsurface region 26. Additionally, although the description of the marine survey system 22 is described with one seismic source 32 (represented in FIG. 2 as an air gun array) and one receiver 36 (represented in FIG. 2 as a set of hydrophones), it should be noted that the marine survey system 22 may include multiple seismic sources 32 and multiple receivers 36. In the same manner, although the above descriptions of the marine survey system 22 is described with one seismic streamer 34, it should be noted that the marine survey system 22 may include multiple streamers similar to streamer 34. In addition, additional vessels 30 may include additional seismic source(s) 32, streamer(s) 34, and the like to perform the operations of the marine survey system 22.

FIG. 3 is a block diagram of a land survey system 38 (e.g., for use in conjunction with block 12 of FIG. 1) that may be employed to obtain information regarding the subsurface region 26 of the Earth in a non-marine environment. The land survey system 38 may include a land-based seismic source 40 and land-based receiver 44. In some embodiments, the land survey system 38 may include multiple land-based seismic sources 40 and one or more land-based receivers 44 and 46. Indeed, for discussion purposes, the land survey system 38 includes a land-based seismic source 40 and two land-based receivers 44 and 46. The land-based seismic source 40 (e.g., seismic vibrator) that may be disposed on a surface 42 of the Earth above the subsurface region 26 of interest. The land-based seismic source 40 may produce energy (e.g., sound waves, seismic waveforms) that is directed at the subsurface region 26 of the Earth. Upon reaching various geological formations (e.g., salt domes, faults, folds) within the subsurface region 26 the energy output by the land-based seismic source 40 may be reflected off of the geological formations (e.g., subsurface reflectors 29) and acquired or observed by one or more land-based receivers (e.g., 44 and 46).

In some embodiments, the land-based receivers 44 and 46 may be dispersed across the surface 42 of the Earth to form a grid-like pattern. As such, each land-based receiver 44 or 46 may receive a reflected seismic waveform in response to energy being directed at the subsurface region 26 via the seismic source 40. In some cases, one seismic waveform produced by the seismic source 40 may be reflected off of different geological formations and received by different receivers. For example, as shown in FIG. 3, the seismic source 40 may output energy that may be directed at the subsurface region 26 as seismic waveform 48. A receiver 44 may receive the reflection of the seismic waveform 48 off of one geological formation and a receiver 46 may receive the reflection of the seismic waveform 48 off of a different geological formation. As such, the receiver 44 may receive a reflected seismic waveform 50 and the receiver 46 may receive a reflected seismic waveform 52.

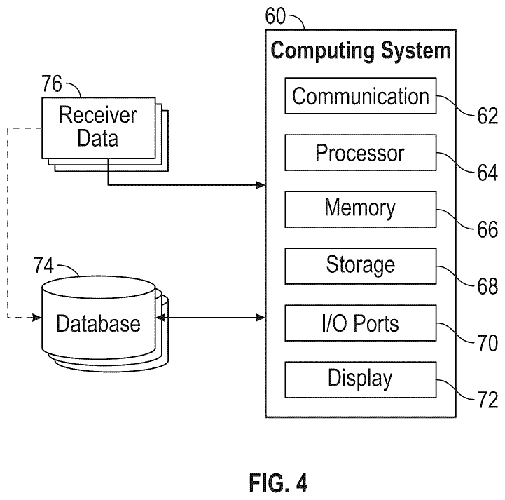

Regardless of how the seismic data is acquired, a computing system (e.g., for use in conjunction with block 12 of FIG. 1) may analyze the seismic waveforms acquired by the receivers 36, 44, 46 to determine seismic information regarding the geological structure, the location and property of hydrocarbon deposits, and the like within the subsurface region 26. FIG. 4 is a block diagram of an example of such a computing system 60 that may perform various data analysis operations to analyze the seismic data acquired by the receivers 36, 44, 46 to determine the structure and/or predict seismic properties of the geological formations within the subsurface region 26.

Referring now to FIG. 4, the computing system 60 may include a communication component 62, a processor 64, memory 66, storage 68, input/output (I/O) ports 70, and a display 72. In some embodiments, the computing system 60 may omit one or more of the display 72, the communication component 62, and/or the I/O ports 70. The communication component 62 may be a wireless or wired communication component that may facilitate communication between the receivers 36, 44, 46, one or more databases 74, other computing devices, and/or other communication capable devices. In one embodiment, the computing system 60 may receive receiver data 76 (e.g., seismic data, seismograms, etc.) via a network component, the database 74, or the like. The processor 64 of the computing system 60 may analyze or process the receiver data 76 to ascertain various features regarding geological formations within the subsurface region 26 of the Earth.

The processor 64 may be any type of computer processor or microprocessor capable of executing computer-executable code. The processor 64 may also include multiple processors that may perform the operations described below. The memory 66 and the storage 68 may be any suitable articles of manufacture that can serve as media to store processor-executable code, data, or the like. These articles of manufacture may represent computer-readable media (e.g., any suitable form of memory or storage) that may store the processor-executable code used by the processor 64 to perform the presently disclosed techniques. The processor 64 may execute software applications that include programs that process seismic data acquired via receivers of a seismic survey according to the embodiments described herein.

With one or more embodiments, processor 64 can instantiate or operate in conjunction with one or more seismic inversion techniques. With another embodiment, the computing system 60 can be implemented by using neural networks. The one or more neural networks can be software-implemented or hardware-implemented. One or more of the neural networks can be a convolutional neural network.

The memory 66 and the storage 68 may also be used to store the data, analysis of the data, the software applications, and the like. The memory 66 and the storage 68 may represent non-transitory computer-readable media (e.g., any suitable form of memory or storage) that may store the processor-executable code used by the processor 64 to perform various techniques described herein. It should be noted that non-transitory merely indicates that the media is tangible and not a signal.

The I/O ports 70 may be interfaces that may couple to other peripheral components such as input devices (e.g., keyboard, mouse), sensors, I/O modules, and the like. I/O ports 70 may enable the computing system 60 to communicate with the other devices in the marine survey system 22, the land survey system 38, or the like via the I/O ports 70.

The display 72 may depict visualizations associated with software or executable code being processed by the processor 64. In one embodiment, the display 72 may be a touch display capable of receiving inputs from a user of the computing system 60. The display 72 may also be used to view and analyze results of the analysis of the acquired seismic data to determine the geological formations within the subsurface region 26, the location and property of hydrocarbon deposits within the subsurface region 26, predictions of seismic properties associated with one or more wells in the subsurface region 26, and the like. The display 72 may be any suitable type of display, such as a liquid-crystal display (LCD), plasma display, or an organic light-emitting diode (LED) (or OLED) display, for example. In addition to depicting the visualization described herein via the display 72, it should be noted that the computing system 60 may also depict the visualization via other tangible elements, such as paper (e.g., via printing) and the like.

With the foregoing in mind, the present techniques described herein may also be performed using a supercomputer that employs multiple computing systems 60, a cloud-computing system, or the like to distribute processes to be performed across multiple computing systems 60. In this case, each computing system 60 operating as part of a super computer may not include each component listed as part of the computing system 60. For example, each computing system 60 may not include the display 72 since multiple displays 72 may not be useful to for a supercomputer designed to continuously process seismic data.

After performing various types of seismic data processing, the computing system 60 may store the results of the analysis in one or more databases 74. The databases 74 may be communicatively coupled to a network that may transmit and receive data to and from the computing system 60 via the communication component 62. In addition, the databases 74 may store information regarding the subsurface region 26, such as previous seismograms, geological sample data, seismic images, and the like regarding the subsurface region 26.

Although the components described above have been discussed with regard to the computing system 60, it should be noted that similar components may make up the computing system 60. Moreover, the computing system 60 may also be part of the marine survey system 22 or the land survey system 38, and thus may monitor and control certain operations of the seismic sources 32 or 40, the receivers 36, 44, 46, and the like. Further, it should be noted that the listed components are provided as example components and the embodiments described herein are not to be limited to the components described with reference to FIG. 4.

In some embodiments, the computing system 60 may generate a 2D representation or a 3D representation of the subsurface region 26 based on the seismic data received via the receivers mentioned above. Additionally, seismic data associated with multiple source/receiver combinations may be combined to create a near continuous profile of the subsurface region 26 that can extend for some distance. In a 2D seismic survey, the receiver locations may be placed along a single line, whereas in a 3D survey the receiver locations may be distributed across the surface in a grid pattern. As such, a 2D seismic survey may provide a cross sectional picture (vertical slice) of the Earth layers as they exist directly beneath the recording locations. A 3D seismic survey, on the other hand, may create a data “cube” or volume that may correspond to a 3D picture of the subsurface region 26.

In addition, a four-dimensional (4D) (or time-lapse) seismic survey may include seismic data acquired during a 3D survey at multiple times. Using the different seismic images acquired at different times, the computing system 60 may compare the two images to identify changes in the subsurface region 26.

In any case, a seismic survey may be composed of a very large number of individual seismic recordings or traces. As such, the computing system 60 may be employed to analyze the acquired seismic data to obtain an image representative of the subsurface region 26 and to determine locations and properties of hydrocarbon deposits. To that end, a variety of seismic data processing algorithms may be used to remove noise from the acquired seismic data, migrate the pre-processed seismic data, identify shifts between multiple seismic images, align multiple seismic images, and the like.

After the computing system 60 analyzes the acquired seismic data, the results of the seismic data analysis (e.g., seismogram, seismic images, map of geological formations, etc.) may be used to perform various operations within the hydrocarbon exploration and production industries. For instance, as described above, the acquired seismic data may be used to perform the method 10 of FIG. 1 that details various processes that may be undertaken based on the analysis of the acquired seismic data.

As described above, seismic surveys reflect seismic waves off of features of earthen subsurface regions in order to collect information regarding the subsurface regions. The information collected from the reflected seismic waves may be used to create velocity models and seismic images which may be used to identify subterranean features of interest such as, for example, hydrocarbon deposits. The velocity models and seismic images may be used to identify locations of hydrocarbon deposits in the subsurface of the Earth and parameters for hydrocarbon exploration (e.g., path along which to drill into the subsurface of the Earth, speed and/or angle in which to drill into the subsurface of the Earth, and the like).

Seismic imaging typically includes a two-step process. First, a velocity model of the subsurface region is estimated. Then, seismic traces obtained from a seismic survey are combined with the estimated velocity model to generate an image of the subsurface structure using migration or imaging algorithms. As used herein, “migration” refers to a seismic data processing technique which shifts or relocates seismic reflections captured in the observed seismic data to or at least towards their true physical positions in the subsurface region to create an image. As used herein, “observed seismic data” refers to data that is captured by one or more seismic receivers as seismic signals reflected by the subsurface region and which are originally generated by one or more corresponding sources. In some applications, an iterative data-fitting process such as a full waveform inversion (FWI) process may be applied to observed seismic data (e.g., seismic data collected using a seismic survey system such as survey systems 22 and 38) to form a velocity model therefrom. An FWI process may begin with an initial estimate of a velocity model and observed seismic data. The method can create a synthetic model based on a geometry of the observed seismic data and the velocity model to produce modeled seismic data, which the method can then compare with the corresponding observed seismic data. The velocity model is then updated using a data misfit, and the process can repeat. The iterations can terminate when the magnitude of the misfit between the modeled and observed seismic data becomes sufficiently small.

More particularly, various existing seismic data migration methods are employed in geophysics. These methods are particularly valuable in hydrocarbon exploration for structurally characterizing or describing subsurface regions (e.g., subsurface reservoirs) and identifying hydrocarbon bearing formations or other salient subsurface features contained therein. However, seismic images derived from conventional imaging techniques may encounter various challenges that increase the computational cost, reduce efficiency, and hence compromise the quality of seismic images.

For example, Reverse Time Migration (RTM) is an advanced seismic migration technique that uses full-wavefield modeling to produce highly accurate subsurface images. RTM simulates seismic wave propagation both forward and backward in time. First, seismic waves are modeled as they propagate from the sources such as a source 32 in FIG. 2 or the source 40 in FIG. 3, reflect off subsurface reflectors 29 shown in FIGS. 2 and 3, and then return to the receivers 36, 44, and 46 shown in FIGS. 2 and 3. Afterward, the recorded data is propagated backward through the Earth using the same velocity model, effectively “reversing” the wavefield to its original subsurface position. This dual-direction propagation allows RTM to handle complex subsurface structures, such as steeply dipping layers, salt bodies, or fault zones. RTM may fully account for all wave interactions, including primary reflections, multiples, and diffractions, thereby making RTM particularly useful in regions with complex or heterogeneous geological settings.

Furthermore, angle gathers may be considered a key output in seismic migration, particularly in the context of advanced methods like RTM. The term “angle gathers” may refer to a collection of seismic data sorted by the reflection angle at which seismic waves reflect from subsurface layers. By organizing the data in terms of reflection angles, angle gathers may provide detailed information about the subsurface geometry, including the dip and structure of geological layers. The reflection angle is related to the distance between the source and the receiver (offset), where larger offsets may allow for the capture of more diverse reflection angles. Therefore, sorting seismic data by angle may allow geophysicists to better understand how different subsurface features affect seismic wave propagation. In wave-equation migration processes, angle gathers may be especially useful for assessing the quality of the velocity model, analyzing residual moveout, and improving imaging accuracy in areas with steep dips or complex interfaces. By preserving and analyzing angle-domain data, angle gathers facilitate refining subsurface models to ensure that seismic images are accurate.

However, the computational cost of calculating the angle gathers in the wave-equation migration processes such as RTM is significant due to the need for extensive data processing and the simulation of seismic wave propagation in both forward and backward time. For example, the wave-equation migration processes such as RTM may involve solving the wave equation for the full wavefield, which may be computationally intensive, particularly for 3D datasets with high spatial resolution. Once the migration is complete, sorting seismic data into angle gathers may involve calculating reflection angles at each point by considering offsets between the source and receiver, which increases the complexity of the calculation. Additionally, this sorting process may handle large volumes of prestack information, using substantial memory and storage capacity. Furthermore, the post-processing steps, such as noise reduction, performing quality control for velocity model building, improving structural imaging via illumination weighting, post-migration reprocessing (PMR), and estimation of rock properties through amplitude versus angle (AVA) may add to the computational cost. Therefore, angle gather calculations in RTM are resource-intensive tasks.

The present disclosure solves the aforementioned technical problems involved in migration and angle gather computations by providing a method for outputting sparse angle gathers from RTM based on plane-wave decomposition. The sparse angle gathers may be obtained by dividing both source and receiver wavefields in a wavenumber domain into several sectors. The term “sector” refers to a section of wavefield in the wavenumber domain, in which the section of the wavefield has a pre-defined angle range, as further described herein. The embodiments disclosed herein improve computational efficiency by outputting a limited number of sectors and avoiding calculating a point by point wavenumber-domain convolution, as further described herein. The method decomposes the source and receiver wavefields based on propagation directions and then cross-correlates the decomposed wavefields, thereby enabling quality control for velocity model building and selective stacking operations to be computationally viable.

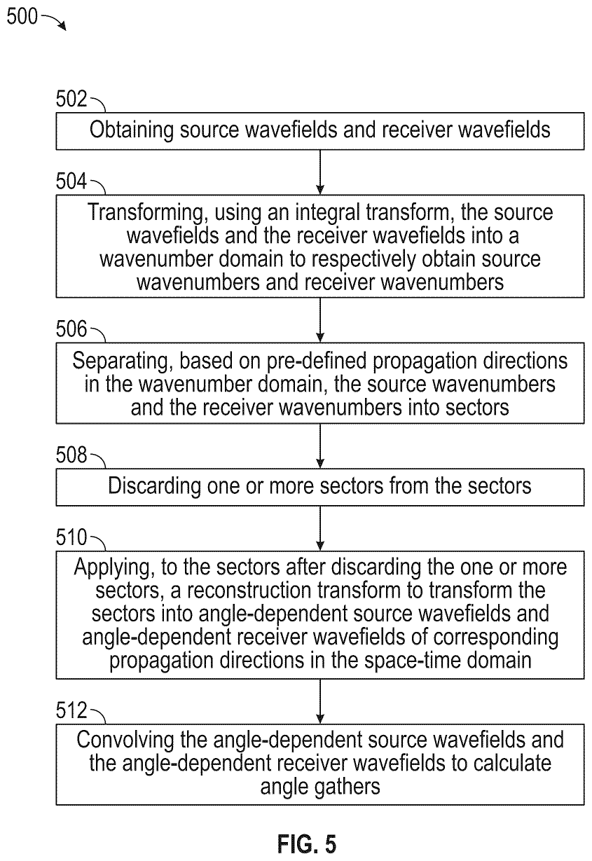

Referring now to FIG. 5, shown is a flowchart illustrating a method 500 of sparse angle gather generation in wave-equation migration according to various embodiments of the disclosure. At least some, if not all, of the steps of method 500 shown in FIG. 5 may be executed by the computing system 60 shown in FIG. 4, although it may be understood that at least some of the steps of method 500 may be executed by systems other than computing system 60. Additionally, it may be understood that the migration of seismic data described by method 500 may be used for a variety of purposes, including volumetric analysis and in the planning hydrocarbon exploration, which would extend through the subsurface region. Thus, method 500 may be used in the process of generating final seismic data including final migrated seismic data, which may include, for example, final migrated seismic gathers and/or one or more final stacked seismic images of the subsurface region.

Beginning at step 502, method 500 comprises obtaining, by the computing system 60, the source wavefields and receiver wavefields. The source wavefields refer to the seismic waves that originate from a seismic source, such as source 32 in FIG. 2 or source 40 in FIG. 3, and may describe the propagation of seismic waves through the Earth as interactions with subsurface structures occur. The receiver wavefields refer to the seismic waves that have originated from locations of the receivers such as receivers 36, 44, and 46 in FIG. 2 and FIG. 3. In an embodiment, the computing system 60 may directly acquire data associated with or descriptive of these wavefields from sources, such as sources 32 and 40 shown in FIG. 2 and FIG. 3 and seismic receivers, such as receivers 36, 44, and 46, shown in FIG. 2 and FIG. 3. Alternatively, the seismic receivers may store data associated with or descriptive of the wavefields in the database 74, from which the computing system 60 can retrieve them. In an embodiment, these wavefields may be defined in the space-time domain, with the source wavefields represented as Uₛ(x, y, z, t) and the receiver wavefields represented as Uᵣ(x, y, z, t).

At step 504, method 500 comprises transforming, by the computing system 60 and using an integral transform, the source and receiver wavefields into the wavenumber domain to obtain corresponding source and receiver wavenumbers. The wavenumber domain refers to a representation of seismic wavefields in terms of spatial frequencies, where the wavenumber is the reciprocal of the wavelength. The wavenumber is often denoted as “k,” and may describe the number of wavelengths per unit distance, with higher wavenumbers corresponding to shorter wavelengths. The wavefields in the wavenumber domain may be analyzed to understand the propagation characteristics of waves and to apply filtering techniques or inversion processes, such as in Fourier transforms. Wave components such as reflections and diffractions may be efficiently isolated or enhanced by performing computations in the wavenumber domain. Source and receiver wavefields may be in either wavenumber-time domain or wavenumber-frequency domain. If in wavenumber-time domain, up-going and down-going waves may be separated using Hilbert transform, otherwise if in wavenumber-frequency domain, additional 1D FFT may be used to convert time domain to frequency domain.

The source wavenumbers may represent the spatial frequencies of the source wavefields generated by the source that propagate through the Earth. The source wavenumbers may further describe how the wavefield emanates from the source location, with each wavenumber component corresponding to a specific wavelength. The receiver wavenumbers, on the other hand, refer to the spatial frequencies of the receiver wavefields that have originated from locations of the receivers. This integral transform may serve to map the wavefields from the space-time domain into the wavenumber-time domain. For example, the integral transform may include techniques such as a 3D Fourier transform, a CWT, a slant stack transform, a Radon transform, or Curvelet transform. As should be appreciated, the method used in the integral transform is not limited to any specific transform, and any suitable integral transform function can be used to perform the conversion of the source and receiver wavefields from the space-time domain to the wavenumber-time domain.

At step 506, method 500 comprises separating, by the computing system 60, the source and receiver wavenumbers into sectors based on predefined propagation directions in the wavenumber domain. The predefined propagation directions in the wavenumber domain may be based on the combination of the azimuth and inclination angles, which describe the spatial orientation of a seismic wave vector in relation to the subsurface. The azimuth angle may represent the horizontal direction of wave propagation relative to a fixed reference such as a source or a receiver, and may measure in degrees from 0° indicating the angle in the horizontal plane. The inclination angle may measure the steepness of the wave trajectory with respect to the vertical axis, with values ranging from 0° for vertical propagation to 90° for horizontal propagation. Together, these two angles may define the predefined propagation directions of the wavefields in the wavenumber domain.

The predefined propagation directions may be used to divide the source and receiver wavenumbers obtained in step 504 into sectors. As described before, the term “sector” refers to a section of wavefield in the wavenumber domain having a pre-defined angle range. Therefore, the number of sectors may depend on the number of predefined propagation directions. A higher number of sectors may be obtained with a higher number of predefined propagation directions and a lower number of sectors may be obtained with a lower number of predefined propagation directions.

In an embodiment, the number of the predefined propagation directions may be based on a desired angle resolution, which may set by the user (e.g., via a user interface). For instance, the source and receiver wavenumbers may be divided into twelve equally spaced sectors using twelve equally spaced predefined propagation directions for low angle resolution images of the subsurface, or into thirty equally spaced sectors using thirty equally spaced predefined propagation directions for higher angle-resolution images. Therefore, the user can dynamically set a quantity or number of predefined propagation directions to set the number of sectors for the wavenumbers and set a quality level for the image based on available computational resources and the intended use of the final results. In an embodiment, the predefined propagation directions may be set to obtain equal size sectors. In this case, the angle range of each of the sectors may be substantially the same. In another embodiment, the predefined propagation directions may set to obtain sectors with different sizes. In this case, the angle range of each of the sectors may be different.

Once the source and receiver wavenumbers are separated into the sectors, at step 508, method 500 comprises discarding, by the computing system 60, one or more sectors from these sectors (e.g., based on a noise level in each of the sectors and/or an angle range of the one or more sectors). In an embodiment, the one or more sectors of the sectors may contain noise and those one or more sectors may be discarded from the sectors such that the remaining sectors may include the least amount of noise among the sectors. In another embodiment, the sectors may not contain noise or the noise levels of the sectors may be under a threshold and hence, all of the sectors may be used for further calculations without discarding any sectors. In this way, a subset of the sectors may be filtered out as containing over a threshold level of noise to obtain sectors that may individually or cumulatively include less than the threshold level of noise. While method 500 shown in FIG. 5 includes step 508 to discard one or more sectors from these sectors, it should be appreciated that in other embodiments, method 500 may not necessarily include step 508 (i.e., sectors may not be discarded during method 500).

At step 510, method 500 comprises applying, by the computing system 60, a reconstruction transform to the sectors after discarding the one or more sectors, converting them into angle-dependent source wavefields and angle-dependent receiver wavefields corresponding to the predefined propagation directions in the space-time domain. For example, the reconstruction transform may include an inverse Fourier transform, an inverse CWT, an inverse slant stack transform, an inverse Radon transform, or an inverse Curvelet transform. As should be appreciated, the method used for the reconstruction transform should not be limited to any particular transform, and any suitable integral transform can be used to map the sectors into the angle-dependent source and the angle-dependent receiver wavefields in the space-time domain. These wavefields may be defined in the space-time domain, with the angle-dependent source wavefields represented as Uₛ(x, y, z, t, β) and the angle-dependent receiver wavefields represented as Uᵣ(x, y, z, t, β), where β denotes the predefined propagation direction that includes both azimuth and inclination angles.

At step 512, the method 500 comprising convolving, by the computing system 60, the angle-dependent source wavefields and the angle-dependent receiver wavefields to calculate the angle gathers. Convolving the angle-dependent receiver wavefields and the angle-dependent source wavefields may generate reflection angles (θ) and azimuth angles (φ). This convolution combines the seismic wavefields generated by the source and the receivers, allowing for the identification of the reflection angles, which is the half of angle between the reflected wave and incident wave. The convolution process may further enable the determination of the azimuth angles, which defines the horizontal direction of the wave propagation that may be measured relative to a reference direction (e.g., east). By sorting the convolved wavefield data based on these angles, angle gathers may be generated, in which seismic events are grouped by the reflection and azimuth angles indicated in the angle gathers. In this way, angle gathers may provide detailed information about the subsurface structures such as, for example, the geometry of faults, layers, and other geological features.

The embodiments disclosed herein significantly reduce computational resource requirements by calculating sparse angle gathers and preserving valuable subsurface information at a fraction of the computational cost. For instance, the embodiments disclosed herein obtains sectors of source wavefields and receiver wavefields for convolving at the space-time domain, which is far less computationally and resource intensive process when compared to convolving each wavenumber corresponding to the source and receiver wavefields in the wavenumber domain, which is far more computationally and resource intensive. This ensures that critical subsurface details are retained while optimizing computational efficiency.

In an embodiment, a user may first perform a set of angle gathers calculations to obtain low-resolution images of the entire subsurface structure. This initial step involves selecting a lower number of predefined propagation directions (e.g., via the user interface 800 further described below), which results in fewer sectors and produces, by performing method 500, low angle-resolution angle gathers. The low angle-resolution calculations are computationally efficient and utilize minimal resources. Afterward, the user can identify a region of interest (ROI) within the subsurface from the low angle-resolution angle gathers. Once the ROI is identified, the user may focus on the ROI by increasing the number of predefined propagation directions, and calculating or selecting a higher number of sectors. This second set of angle gathers calculations is performed, using method 500, with a higher angle-resolution, providing more detailed images of the ROI. Since the predefined propagation directions are specifically focused on the ROI, the second set of angle gathers offers high angle-resolution results while still maintaining an efficient use of computational resources. This approach allows for detailed imaging of critical subsurface areas without requiring excessive computational power, optimizing both the quality of the results and the computational cost.

In an embodiment integral transform comprises a 3D Fourier transform, a CWT, a Curvelet transform, a slant stack transform, or a radon transform. In another embodiment, the reconstruction transform comprises an inverse Fourier transform, an inverse slant stack transform, or an inverse radon transform. In another embodiment, the reconstruction transform further comprises an inverse CWT or an inverse Curvelet transform. In an embodiment, after obtaining the source wavefields and the receiver wavefields, the method further includes performing up/down separation (i.e., by Hilbert transform) on the source wavefields to obtain up-going source wavefields and down-going source wavefields, performing the up/down separation on the receiver wavefields to obtain up-going receiver wavefields and down-going receiver wavefields. In another embodiment, the method includes performing 1D Fourier transform on the source wavefields and receiver wavefields to convert space-time domain into space-frequency domain. In another embodiment, the pre-defined propagation directions each comprise equal angle ranges. In an embodiment, the pre-defined propagation directions each comprise random angle ranges. In an embodiment, discarding the one or more sectors from the sectors comprises maintaining or keeping all of the sectors without discarding any of the sectors. In another embodiment, discarding the one or more sectors from the sectors further comprises discarding an initial sector of the sectors and a last sector of the sectors from the sectors based on angle range of the initial sector and the last sector. In yet another embodiment, before separating the source wavenumbers and the receiver wavenumbers into the sectors, the method further comprises obtaining, using a user interface and from a user, the pre-defined propagation directions. In an embodiment, before separating the source wavenumbers and the receiver wavenumbers into the sectors, the method further comprises obtaining, using a feature selection algorithm and a machine learning model, the pre-defined propagation directions.

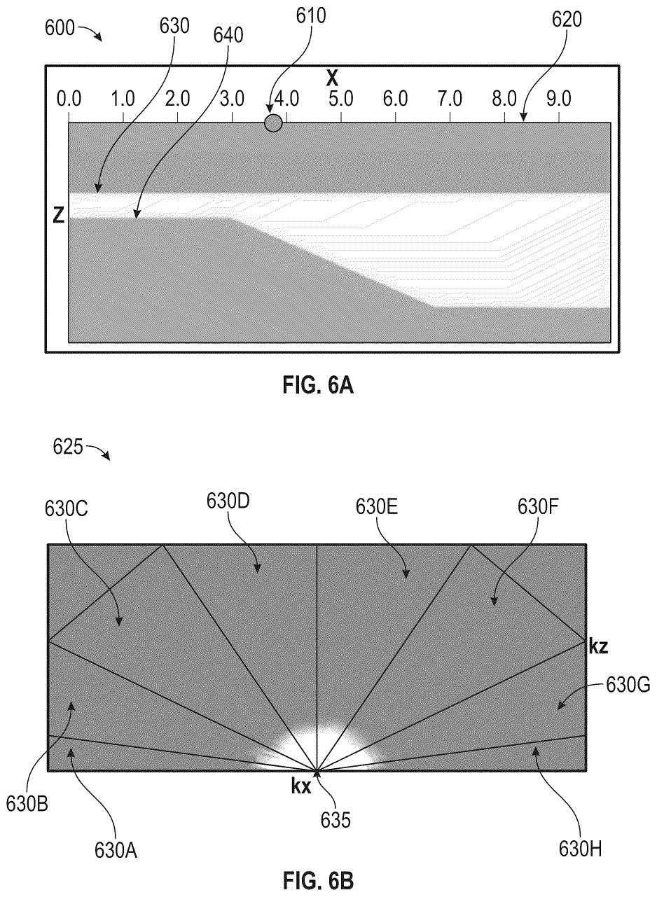

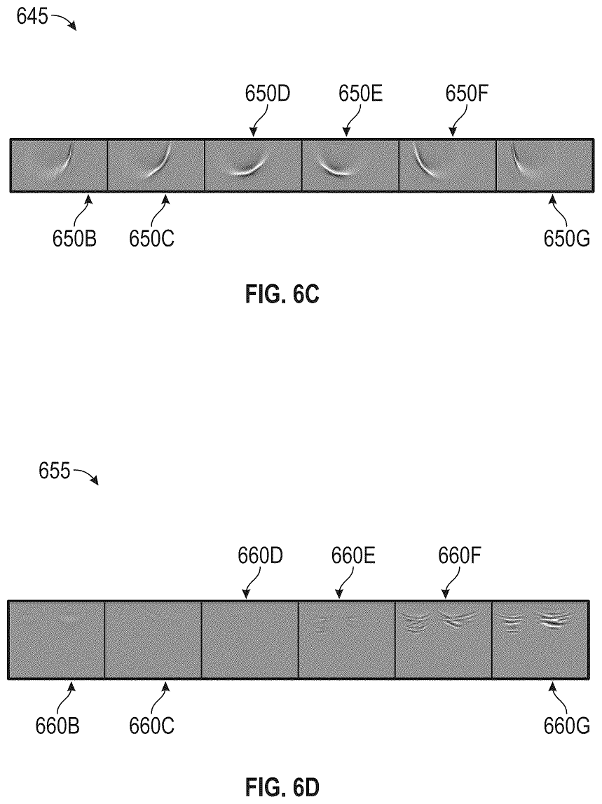

Referring now to FIGS. 6A-6D, shown are images depicting an implementation of method 500 using a synthetic 2D model of a subsurface region. Specifically, FIG. 6A illustrates a synthetic 2D model of a subsurface region, FIG. 6B illustrates the source wavefield in the wavenumber domain for a single source after applying the 3D FFT, FIG. 6C illustrates the separated source wavefields after transforming each of the separated six sectors of wavenumbers back into space (x, y, z), and FIG. 6D illustrates the images of six reflection angles based on the separate source wavefields after the convolving step 512 of method 500 is performed.

Turning first to FIG. 6A, shown is the synthetic 2D model 600 of subsurface regions, which can be used as a simplified representation to understand the behavior of a 3D real-world subsurface regions. In FIG. 6A, the dot 610 represents the source location, while the line 620 along the surface of the Earth indicates the positions of the receivers. In an embodiment, the source wavefields are based on the signals emitted from the source at dot 610 in FIG. 6A, and the receiver wavefields are based on the signals captured by the receivers at line 620, after the signals emitted from the source are reflected from subsurface structures at subsurface regions 630 and 640.

Referring now to FIG. 6B, shown is the source wavefield 625 in the wavenumber domain for a single source located at the location 635 after applying the 3D FFT. Similar representations can be provided for a receiver located at the location 635 and the receiver wavefield 625. As shown in FIG. 6B, the wavefield 625 is separated into eight sectors 630A-H based on pre-defined propagation directions in the wavenumber domain. Each pre-defined propagation direction may correspond to a pair of azimuth and inclination angles and may be used to separate the wavefield 625 into the sectors 630A-H.

As shown in FIG. 6B, the wavefield 625 is separated into eight sectors 630A-H, from the location point 635 of the source or the receiver, and extending outward in the direction of the of the pre-defined propagation directions. The sector 630A is the sector on the far left, extending in a propagation direction from the location point 635. The sector 630B is the next sector (to the right of and) adjacent to the sector 630A, extending in a propagation direction from the location point 635. The sector 630C is the next sector (to the right of and) adjacent to the sector 630B, extending in a propagation direction from the location point 635. The sector 630D is the next sector (to the right of and) adjacent to the sector 630C, extending in a propagation direction from the location point 635. The sector 630E is the next sector (to the right of and) adjacent to the sector 630D, extending in a propagation direction from the location point 635. The sector 630F is the next sector (to the right of) adjacent to the sector 630E, extending in a propagation direction from the location point 635. The sector 630G is the next sector (to the right of and) adjacent to the sector 630F, extending in a propagation direction from the location point 635. The sector 630H is the next sector (to the right of and) adjacent to the sector 630G, extending in a propagation direction from the location point 635.

In an embodiment, a user may view the wavefield 625 on a display of a computer system 60. The user may perform step 508 of method 500 to discarding sectors 630A and 630H (or maintaining a subset of the sectors 630A-H) to be used in the convolution step 512 of method 500 based on various factors. For example, the factors for maintaining of the sectors 630B-G (or discarding sectors 630A and 630H) may be based on the types of data provided in each sector 630A-H of the wavefield 625, the size of sector in each sector 630A-H of the wavefield 625, or quality of data (e.g., signal-to-noise (S/N) ratio) provided in each sector 630A-H of the wavefield 625, etc. In this way, discarding sectors 630A and 630H from the sectors 630A-H filters out the sectors 630A and 630H from the computations, since this data is not as relevant or beneficial in the convolution step 512 of method 500. In an embodiment, the sectors 630A and 630H may contain the lowest S/N ratio and incorporating the sectors 630A and 630H into the convolution step 512 may add artifacts to the angle gathers and providing incorrect information about the subsurface region. Therefore, the sectors 630A and 630H may be filtered out from the sectors 630A-630H of the wavefield 625 when maintaining the sectors 630B-G of the wavefield 625 in step 508. In an embodiment, all the S/N ratios of the sectors 630A-H of the wavefield 625 may have higher values than a preset threshold and therefore, in step 508 of method 500, all the sectors 630A-H of the wavefield 625 may maintained as the sectors without discarding any of the sectors 630A-H.

Referring now to FIG. 6C, shown is a collection of transformed source wavefields 645 after each of the six sectors 630B-G of wavenumbers is converted back into the space-time domain by performing step 510 in method 500. FIG. 6C shows the source wavefields 650B-G respectively corresponding to the sectors 630B-G. Similar to the transformed source wavefields 650B-G, transformed receiver wavefields may also be obtained by performing step 510 of the method 500 on each of the six sectors of wavenumbers on the receiver side. After obtaining the transformed source wavefields 650B-G and the transformed receiver wavefields, the convolution step 512 of method 500 is performed to obtain the angle gathers.

Referring now to FIG. 6D, shown is the collection 655 of resulting decomposed images 660B-G at six reflection angles based on the transformed source wavefields 645 and transformed receiver wavefields. In an embodiment, the reflection angles may be obtained by performing the convolution step 512 of method 500 on the transformed source wavefields 650B-G and the transformed receiver wavefields. Each of the decomposed images 660B-G may represent a different reflection angle. Similar resulting decomposed images at six azimuth angles may be obtained in 3D when performing the convolution step 512 of method 500. By sorting the convolved wavefield data based on these angles, angle gathers may be generated.

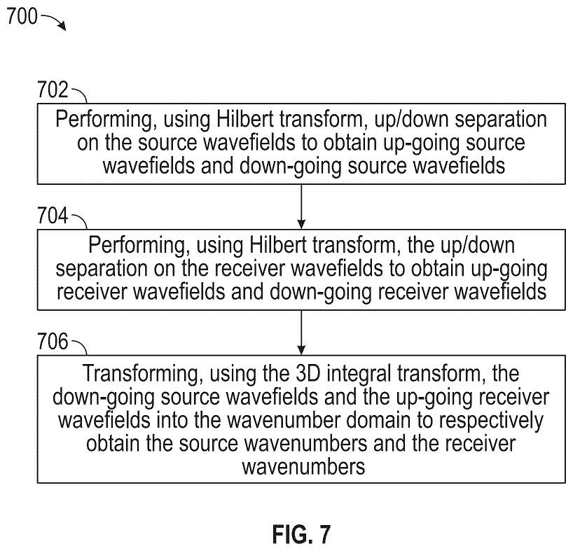

Turning now to FIG. 7, shown is a flowchart illustrating a method 700 of sparse angle gather generation in wave-equation migration according to various embodiments of the disclosure. At least some, if not all, of the steps of method 700 shown in FIG. 7 may be executed by the computing system 60 shown in FIG. 4, although it may be understood that at least some of the steps of method 700 may be executed by systems other than computing system 60. Additionally, it may be understood that the migration of seismic data described by method 700 may be used for a variety of purposes, including volumetric analysis and in the planning hydrocarbon exploration, which would extend through the subsurface region. Thus, method 700 may be used in the process of generating final seismic data including final migrated seismic data, which may include, for example, final migrated seismic gathers and/or one or more final stacked seismic images of the subsurface region.

In an embodiment, the method 700 may be applied into wavefields in the space-frequency domain before separating wavefields by propagation directions. First, the wavefields in the space-time domain may be converted into the space-frequency domain for further processing. This conversion may be performed by applying the 1D Fourier transform along the time axis to transform the space-time domain representations of the wavefields into their corresponding space-frequency domain wavefields. Then the method comprises transforming, by the computing system 60 and using a 3D integral transform, source wavefields and the receiver wavefields into the frequency-wavenumber domain, as previously shown in method 500.

At step 702, method 700 includes performing, by the computer system 60 and in some cases, using Hilbert transform, up/down separation on the source wavefields, resulting in the extraction of up-going and down-going source wavefields in a space-time domain. Similarly, at step 704, method 700 comprises performing, by the computing system 60 and in some cases, using Hilbert transform, up/down separation on the receiver wavefields, obtaining both the up-going and down-going receiver wavefields. Furthermore, the down-going source and receiver wavefields represent energy propagating towards the subsurface, while the up-going source and receiver wavefields are those reflected from subsurface structures. As mentioned above, since 1D Fourier transform along the time axis may be computationally expensive, the embodiments disclosed herein separate the wavefields into components based on the direction of propagation (the aforementioned up-going or down-going (i.e., into the subsurface or reflected away from the subsurface)). This separation may allow the method to focus only on the relevant wavefield components necessary for the inversion or imaging process, reducing computational load while maintaining the fidelity of the results. For example, convolve down-going source wavefield sectors and up-going receiver wavefield sectors, or convolve down-going receiver wavefield sectors and up-going source wavefield sectors after separating the sectors based on the pre-defined propagation directions.

At step 706, method 700 comprises transforming, by the computing system 60, using a 3D integral transform, the down-going source wavefields and the up-going receiver wavefields.

This transform specified at step 706 converts the wavefields into the time-wavenumber domain, resulting in the calculation of the source wavenumbers and receiver wavenumbers. After obtaining the source and receiver wavenumbers, the method 700 proceeds with steps 506, 508, 510, and 512 of method 500 of FIG. 5, which are not repeated here for brevity.

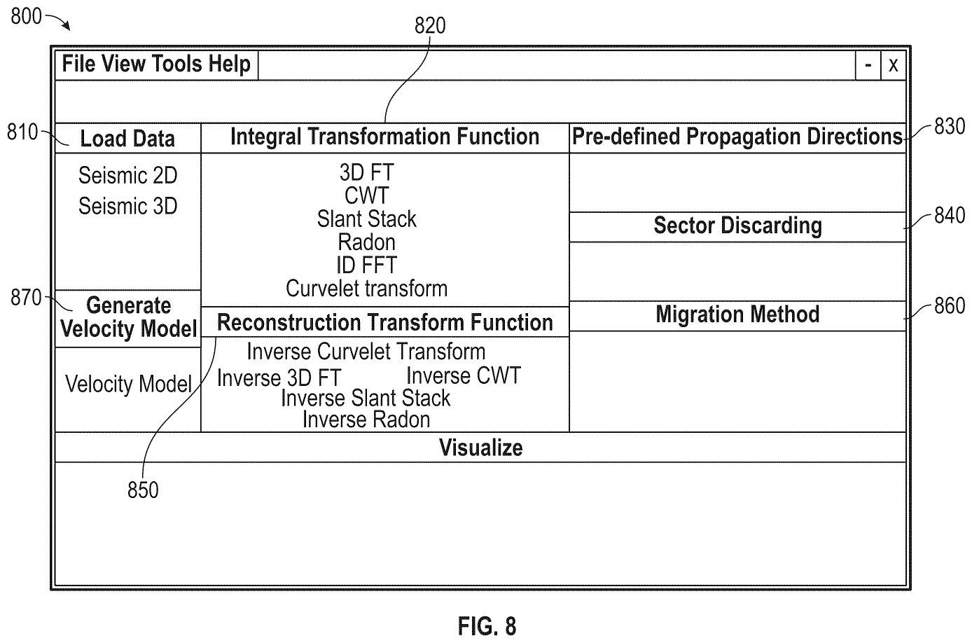

Referring now to FIG. 8, shown is a user interface 800 that may be displayed on a display 72 of the computing system 60 (or integrated with the computing system 60) according to various embodiments of the disclosure. The user interface 800 allows the user to input parameters that define the angle gather calculations specified in method 500 and method 700. The user interface 800 includes several interactive sections for different tasks. For example, through the Load Data tab 810, the user can load seismic data, such as 2D or 3D seismic datasets (e.g., as described in step 502 of method 500). The Integral Transformation Function tab 820 enables the user to select or otherwise indicate the integral transform function to be used in the angle gather calculations (e.g., as described in step 504 of method 500). The Pre-defined Propagation Directions tab 830 allows the user to define (e.g., manually type in or select) the propagation directions to be applied in the angle gather calculations (e.g., as in step 506 of method 500, where for example, the user may select available samples angles from a drop-down menu).

The Sector Discarding tab 840 lets the user discard one or more sectors from the sectors to maintain certain sectors to be used in the angle gather computations (e.g., as in step 508 of method 500 where for an example, the user may interact, using this tab, with the wavefields displayed in the visual represent and maintain all the sectors or discard/filter out one or more sectors from the sectors). Through the Reconstruction Transform Function tab 850, the user may select the reconstruction transform function that may convert the sectors into the space-time domain (e.g., step 510 of method 500). The Migration Method tab 860 enables the user to select the wave-equation migration method, such as Reverse-Time Migration (RTM), One-Way wave-equation Migration (WEM), Common-Reflection-Surface (CRS) Migration, Least-Squares Reverse-Time Migration (LSRTM), Full-Waveform Inversion (FWI), or other suitable techniques. The FWI here is defined to include all variants of full-waveform inversion. Certain examples of full-waveform inversion can use pressure and/or multi-component data. Certain examples of full-waveform inversion can use different approximations of physics (such as, for example, acoustic, elastic, visco-elastic, isotropic, and/or anisotropic). FWI can be used for different applications such as applications for estimating 3D velocities, applications for performing multi-parameter inversion, applications for deriving reflectivity volumes, applications for determining 4D difference volumes, applications for determining reflectivity gathers, and/or applications for determining probabilistic inversions, to name a few examples.

Finally, Generate Velocity Model tab 870 may allow the user to generate velocity model based on the loaded data. These interactive tabs provide a comprehensive way for the user to configure the necessary parameters for angle gather calculations, enabling a more efficient and tailored seismic imaging workflow.

In an embodiment, FWI may include calculating the gradient of an objective function with respect to model parameters such as velocity or impedance using seismic data at various incident angles. This gradient provides information on how the subsurface model may be updated to reduce the misfit between observed seismic data and modeled seismic data. During FWI, by computing the gradient with respect to the angle gathers obtained using various embodiments described herein, the inversion process may be guided with respect to the angle-dependent behavior of seismic waves and may improve the accuracy of subsurface imaging.

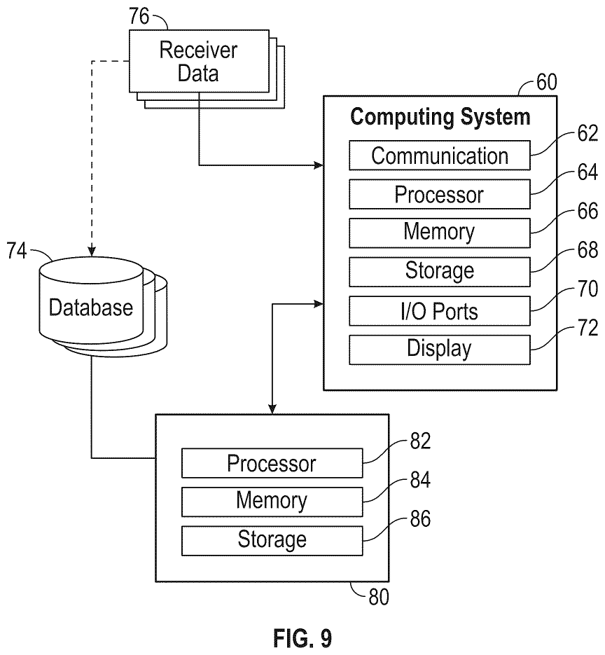

FIG. 9 provides a block diagram of an embodiment of a computer system for generating sparse angle gathers in wave-equation migration, in accordance with the principles disclosed herein. In addition to the components described in the computer system of FIG. 4, the system in FIG. 9 includes a neural networking module 80. This module comprises one or more dedicated processors 82, one or more dedicated memories 84, and one or more dedicated storage devices 86. The neural networking module 80 may either be coupled to the computing system 60 or fully integrated within it. It can also connect to the database 74, enabling it to access seismic data stored there and, in turn, store sparse angle gather data. The memories 84 and storage devices 86 in the neural networking module 80 may contain neural networks, such as Convolutional Neural Networks (CNN), Recurrent Neural Networks (RNN), or other suitable machine learning models. In one embodiment, the computing system 60 may trigger the neural networking module 80 to execute the processes defined in methods 500 and 700. For example, after receiving a trigger from the computing system 60, the neural networking module 80 may assess the available computational resources and review historical data on angle gather parameters used in past calculations. Using this information, the neural networking module 80 may select an appropriate feature selection algorithm and machine learning model to select or otherwise indicate the integral transform function to be used in the angle gather calculations (e.g., as described in step 504 of method 500), define or select the pre-defined propagation directions to be applied in the angle gather calculations, discard one or more sectors from the sectors and may provide the remaining sectors for the angle gather computations, select the reconstruction transform function that will convert the sectors back into the space-time domain, select the migration method, such as RTM, WEM, CRS Migration, LSRTM, FWI, or other suitable techniques, and/or generate velocity model based on the available seismic data.

This approach helps the neural networking module 80 to minimize user bias and identify the optimal parameters, tailored to the specific characteristics of the seismic data.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A method performed by a computer system for obtaining angle gathers from wave-equation migration, wherein the method comprises:
obtaining source wavefields and receiver wavefields, wherein the source wavefields and the receiver wavefields are in a space-time domain;
transforming, using an integral transform, the source wavefields and the receiver wavefields into a wavenumber domain to respectively obtain source wavenumbers and receiver wavenumbers;
separating, based on pre-defined propagation directions in the wavenumber domain, the source wavenumbers and the receiver wavenumbers into sectors;
discarding one or more sectors from the sectors;
applying, to the sectors after discarding the one or more sectors, a reconstruction transform to transform the sectors into angle-dependent source wavefields and angle-dependent receiver wavefields of corresponding propagation directions in the space-time domain; and
convolving the angle-dependent source wavefields and the angle-dependent receiver wavefields to calculate angle gathers.

2. The method of claim 1, wherein the integral transform comprises a three-dimensional (3D) Fourier transform, a complex wavelet transform (CWT), a slant stack transform, a radon transform, or a Curvelet transform.

3. The method of claim 1, wherein the reconstruction transform comprises an inverse Fourier transform, an inverse complex wavelet transform (CWT), an inverse slant stack transform, an inverse radon transform, or an inverse Curvelet transform.

4. The method of claim 1, wherein after obtaining the source wavefields and the receiver wavefields, the method further comprises:
performing, using a Hilbert transform, up/down separation on the source wavefields to obtain up-going source wavefields and down-going source wavefields;
performing, using the Hilbert transform, the up/down separation on the receiver wavefields to obtain up-going receiver wavefields and down-going receiver wavefields; and
transforming, using the integral transform, the down-going source wavefields and the up-going receiver wavefields into the time-wavenumber domain to respectively obtain the source wavenumbers and the receiver wavenumbers.

5. The method of claim 1, wherein after obtaining the source wavefields and the first receiver wavefields, the method further comprises:
performing one-dimensional (1D) Fourier transform on the source wavefields and the receiver wavefields to transform the source wavefields and the receiver wavefields into a space-frequency domain; and
transforming, using the integral transform, the source wavefields and the receiver wavefields that is in the space-frequency domain into wavenumber-frequency domain.

6. The method of claim 1, wherein the pre-defined propagation directions each comprise equal angle ranges.

7. The method of claim 1, wherein the pre-defined propagation directions each comprise random angle ranges.

8. The method of claim 1, wherein discarding the one or more sectors from the sectors further comprises discarding an initial sector of the sectors and a last sector of the sectors.

9. The method of claim 1, wherein before separating the source wavenumbers and the receiver wavenumbers into the sectors, the method further comprises obtaining, using a user interface and from a user, the pre-defined propagation directions.

10. The method of claim 1, wherein before separating the source wavenumbers and the receiver wavenumbers into the sectors, the method further comprises obtaining, using a feature selection algorithm and a machine learning model, the pre-defined propagation directions.

11. A computing system for obtaining angle gathers from wave-equation migration, wherein the computing system comprises:
a memory comprising instructions; and
one or more processors coupled to the memory and configured to execute the instructions to cause the computing system to:
obtain source wavefields and receiver wavefields, wherein the source wavefields and the receiver wavefields are in a space-time domain;
transform, using an integral transform, the source wavefields and the receiver wavefields into a wavenumber domain to respectively obtain source wavenumbers and receiver wavenumbers;
separate, based on pre-defined propagation directions in the wavenumber domain, the source wavenumbers and the receiver wavenumbers into sectors;
discard one or more sectors from the sectors;
apply, to the sectors after discarding the one or more sectors, a reconstruction transform to transform the sectors into angle-dependent source wavefields and angle-dependent receiver wavefields of corresponding propagation directions in the space-time domain; and
convolve the angle-dependent source wavefields and the angle-dependent receiver wavefields to calculate angle gathers.

12. The computing system of claim 11, wherein the integral transform comprises a three-dimensional (3D) Fourier transform, a complex wavelet transform (CWT), a slant stack transform, a radon transform, or a Curvelet transform.

13. The computing system of claim 11, wherein the reconstruction transform comprises an inverse Fourier transform, an inverse complex wavelet transform (CWT), an inverse slant stack transform, an inverse radon transform, or an inverse Curvelet transform.

14. The computing system of claim 11, wherein the one or more processors further configured to execute the instructions to cause the apparatus to:
perform, using a Hilbert transform, up/down separation on the source wavefields to obtain up-going source wavefields and down-going source wavefields;
perform, using a Hilbert transform, the up/down separation on the first receiver wavefields to obtain up-going receiver wavefields and down-going receiver wavefields; and
transform, using the integral transform, the down-going source wavefields and the up-going receiver wavefields into the wavenumber domain to respectively obtain the source wavenumbers and the receiver wavenumbers.

15. The computing system of claim 11, wherein the one or more processors further configured to execute the instructions to cause the apparatus to:
perform one-dimensional (1D) Fourier transform on the source wavefields and the receiver wavefields to transform the source wavefields and the receiver wavefields into a space-frequency domain; and
transform, using the integral transform, the source wavefields and the receiver wavefields that is in the space-frequency domain into wavenumber-frequency domain.

16. The computing system of claim 11, wherein the pre-defined propagation directions each comprise equal angle ranges.

17. The computing system of claim 11, wherein the pre-defined propagation directions each comprise random angle ranges.

18. The computing system of claim 11, wherein the one or more processors further configured to execute the instructions to cause the apparatus to discard an initial sector of the sectors and a last sector of the sectors.

19. A computer program product comprising computer-executable instructions that are stored on a non-transitory computer-readable medium and that, when executed by one or more processors, cause a computing system to:
obtain source wavefields and receiver wavefields, wherein the source wavefields and the receiver wavefields are in a space-time domain;
transform, using an integral transform, the source wavefields and the receiver wavefields into a wavenumber domain to respectively obtain source wavenumbers and receiver wavenumbers;
separate, based on pre-defined propagation directions in the wavenumber domain, the source wavenumbers and the receiver wavenumbers into sectors;
discard one or more sectors from the sectors;
apply, to the sectors after discarding the one or more sectors, a reconstruction transform to transform the sectors into angle-dependent source wavefields and angle-dependent receiver wavefields of corresponding propagation directions in the space-time domain; and
convolve the angle-dependent source wavefields and the angle-dependent receiver wavefields to calculate angle gathers.

20. The computer program product of claim 19, wherein the integral transform comprises a three-dimensional (3D) Fourier transform, a complex wavelet transform (CWT), a slant stack transform, a radon transform, or a Curvelet transform, and wherein the reconstruction transform comprises an inverse Fourier transform, an inverse CWT, an inverse slant stack transform, an inverse radon transform, or an inverse Curvelet transform.
